(19) United States
(12) Patent Application Publication
(10) Pub. No.: US 2001/0050492 A1
(43) Pub. Date: Dec. 13, 2001

(54) Woven protective lining

(76) Inventor: Jordan Janevski, Cabramatta (AU)

Correspondence Address: SMITH-HILL AND BEDELL, 12670 N W BARNES ROAD, SUITE 104, PORTLAND, OR, 97229

(21) Appl. No.: 09/836,962

(22) Filed: Apr. 17, 2001

(30) Foreign Application Priority Data
Apr. 27, 2000 (AU) PQ7113
May 16, 2000 (AU) PQ7511
May 31, 2000 (AU) PQ7828
Sep. 4, 2000 (AU) PQ9859

(51) Int. Cl. B60R 13/01; A41D 1/00; A41D 27/02

(52) U.S. Cl. 296/39.1; 2/97

(57) ABSTRACT

A lining (12) having a relatively high resistance to penetration from small objects, is composed of parallel flexible sheets (14) each made from staggered parallel strips (13) of flat webbing having their longitudinal edges stitched together on both sides of the sheet (14) by stitch lines (15). The webbing is cheaply commercially available as motor vehicle seat-restraint or load restraint webbing, and is made from closely-woven, high tenacity, continuous filament plastics fibers woven together with a non-lattice pattern. The lining can be made cheaply and offers a high resistance to penetration by sharp objects. It can be incorporated into clothing to enhance its strength to penetration by such objects and thus protect the wearer. It can also be provided in multi-layer from behind metal panels of a vehicle to resist ballistic penetration from bullets of small caliber hand-guns.

### FIELD OF THE INVENTION

THIS INVENTION relates to protective linings and, more specifically is concerned with a cheaply fabricated lining offering resistance to injury from violent abrasions and sharp objects which may impact with considerable velocity. In its simplest form the lining may be incorporated into a garment such as a jacket to protect the wearer from injury. An example of such a garment is a jacket or over-trousers of the kind worn by motor cyclists to protect themselves against injury from violent abrasions should they fall off the motorcycle when travelling at speed. The lining may also be made-up in multi-layer form and incorporated into body panelling of a vehicle such as a car, armoured van, aircraft or helicopter to protect vital parts of the vehicle and its personnel against damage and injury from projectiles, such as bullets.

### STATE OF THE ART

A requirement of a protective lining incorporated into a garment is that it should be light and flexible. This is also desirable when fitted behind a metal body panel of a vehicle as it enables the lining to be fitted around parts of the panel which have an irregular surface profile. Such flexibility avoids having to fabricate rigid solid linings of a specific shape in order to provide protection behind such a panel. The manufacture of solid inflexible linings, each unique to a specific panel shape, is costly even if the basic material from which the solid lining is formed is cheap.

Some plastics materials have been developed which can be manufactured as light and flexible loosely-woven sheets which offer a relatively high resistance in most cases to penetration by some projectiles. Such sheets are loosely woven with a conventional lattice pattern, from threads of about 1½ mm diameter and made from a material known under the Registered Trade Mark KEVLAR. In a lattice pattern of woven material, the weft and weave threads extend perpendicularly to one another.

A lining composed of several thin, flexible loosely-woven KEVLAR sheets is sometimes used in garments such as army flak jackets, police waistcoats and other applications where it is required to protect vital organs of the wearer against injury from low calibre hand-gun bullets. Unfortunately KEVLAR is an expensive material and this disadvantage is obviously reflected in the price of the garment.

I have discovered an adverse characteristics of loosely-woven KEVLAR sheets. It appears from ballistic experiments, that a lining composed of several superimposed sheets of loosely-woven KEVLAR degrades rapidly when subjected in rapid succession to impacts from successive rounds of ammunition from a hand-gun such as a 44 calibre magnum.

### OBJECT OF THE INVENTION

An object of the invention is to provide a cheap yet relatively effective protective lining.

### The Invention

In accordance with the present invention a protective flexible lining comprises one or more superimposed flat sheets made up from parallel strips of closely-woven non-lattice pattern webbing fabricated from a high-tenacity, continuous filament, synthetic plastics fiber material.

### Advantages of the Invention

Closely-woven, non-lattice pattern, webbing strips useable for constructing the linings of the invention, is cheaply and readily commercially available for numerous purposes where high tensile strength coupled with flexibility is required. Amongst such purposes may be mentioned flat synthetic-webbing used for slings used in the building industry and conforming to Australian Standard AS 1353.1-1997; webbing for restraining devices for occupants of motor vehicles and conforming to Australian Standard 1753-1990; and cargo restraint systems used for road vehicles in the transport industry and conforming to Australian and New Zealand Standards 4380: 1996; and 4475.2:-1997.

As examples of materials used to provide high tenacity fibers in the above-described webbing, may be mentioned: aramid polyamide; nylon; polyester; and ultra violet, light-stabilised polypropylene. Such webbing strips are commercially available at a cheap price in a wide range of webbing sizes each having its own characteristics as regards weight, thickness, width and tensile strength. Their common characteristic however, is that they use a non-lattice tight weave, and are closely-woven with a thread diameter which is small compared with that used in lattice woven KEVLAR sheets.

Ballistic tests conducted by authorised ballistic testing organisations in Australia have shown that a lining composed of superimposed sheets of the invention offers a superior resistance to penetration by high-velocity projectiles for the same cost per unit area than KEVLAR sheeting. Although KEVLAR sheeting is lighter per unit area than the lining of the invention, this disadvantage is acceptable in many applications where cheapness and durability is a more important consideration than weight.

### Preferred Features of the Invention

In the sheets of the invention it is preferred to stitch the webbing strips to one another on both sides and along both longitudinal edges. Ballistic tests have shown that, surprisingly, the resistance to penetration of the lining at the position of the stitching is not noticeably less than that offered by the unstitched areas of the lining.

When the lining is composed of a large number of sheets, these are preferably fabricated in separate panels each containing a number of superimposed sheets stitched together at their edges. The panels are then stacked one over the other to provide the lining with the required number of sheets, the sheets of contiguous layers preferably having the positions of the strips staggered with respect to one another.

When the lining is to be used to resist penetration from heavy calibre bullets, such as 44 Magnum ammunition, it is preferably formed from a synthetic plastics fiber material other than nylon. Also if a multi-layer lining capable of stopping a 44 magnum bullet is placed behind a 23 mm steel door panel of a vehicle, the metal panel retards or blunts the tip of a 9 mm metal jacketed bullet sufficiently for the lining to stop its motion altogether.

### INTRODUCTION TO THE DRAWINGS

The invention will now be described in more detail, by way of examples, with reference to the accompanying drawings, in which:

### IN THE DRAWINGS

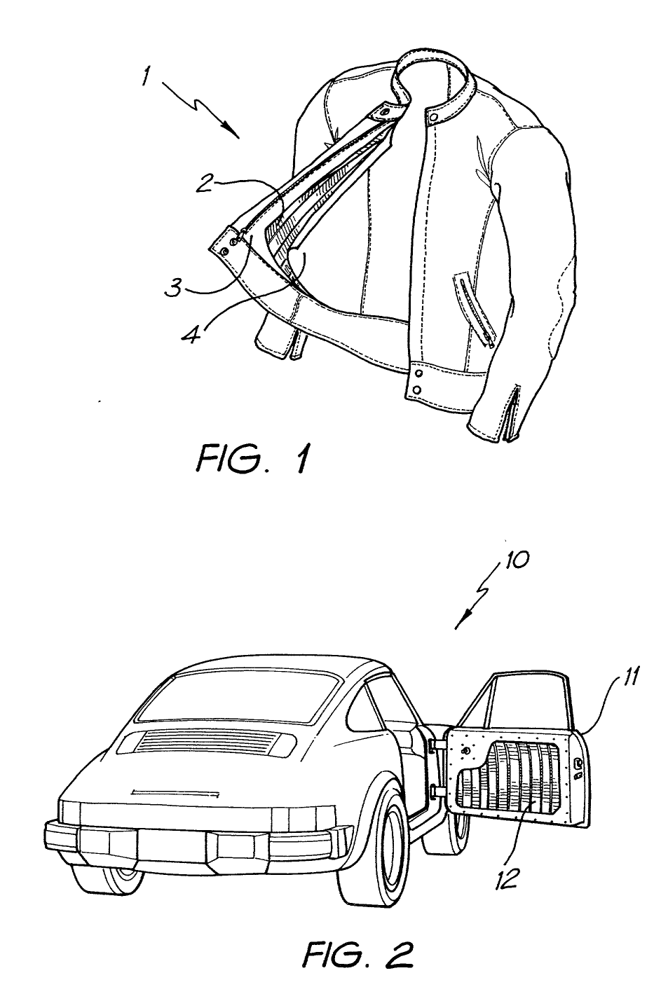

FIG. 1 illustrates a motor cyclejacket, partly broken away, and reinforced with an internal lining;

FIG. 2 illustrates a car having a metal door panel internally backed with a protective multi-layer lining;

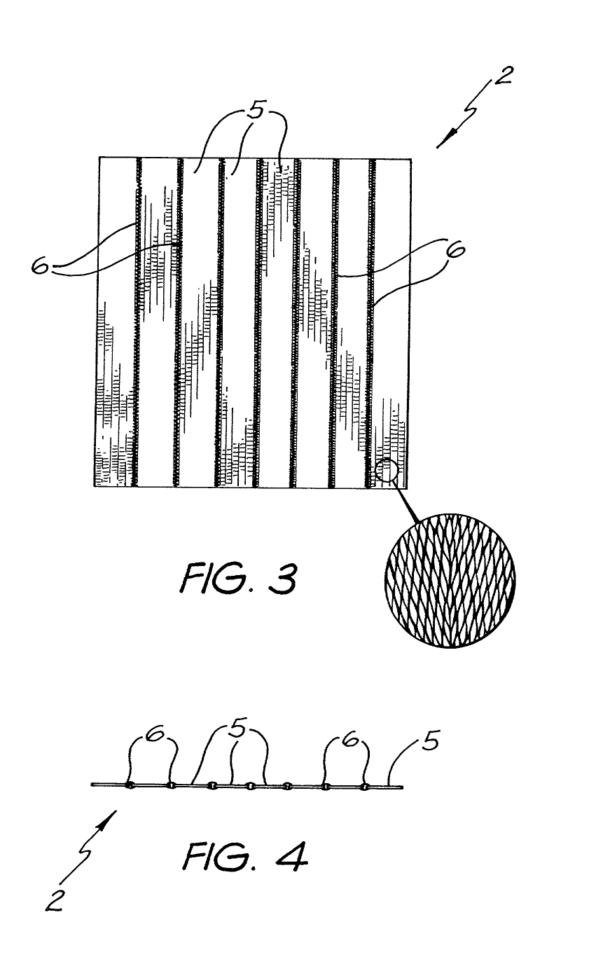

FIG. 3 is a plan view of a diagrammatically illustrated sheet providing a protective lining for the jacket of FIG. 1, parts of the sheet being ringed and shown on a greatly enlarged scale;

FIG. 4 is an end-view of the sheet of FIG. 3;

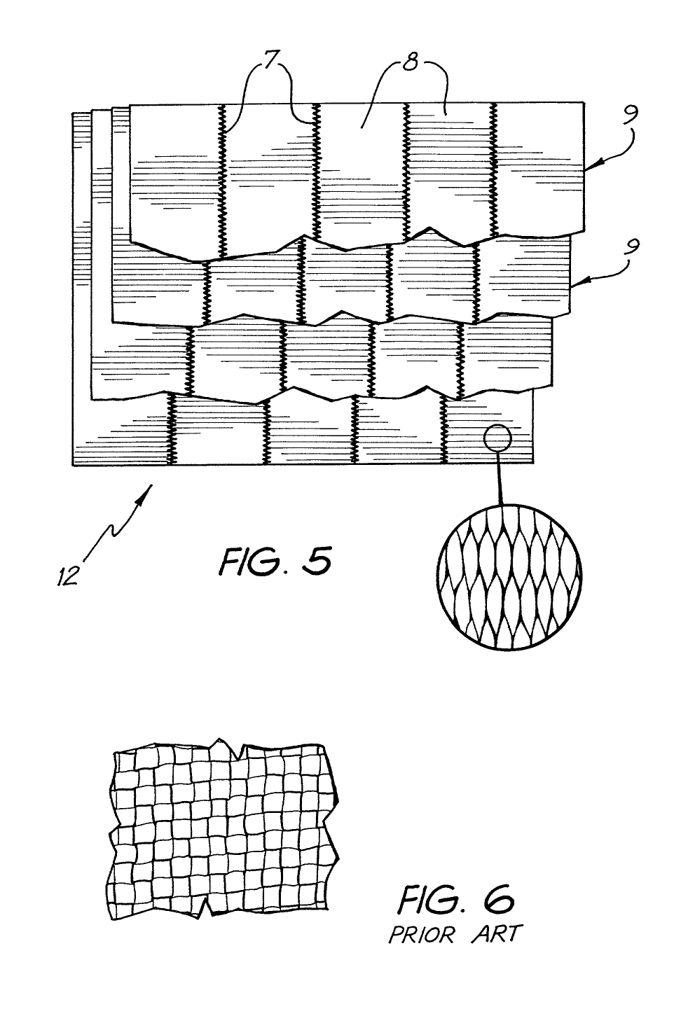

FIG. 5 is a plan view of four of the superimposed sheets of a protective lining used in the door of the vehicle of FIG. 2, the lining being partly broken away to expose internal detail and a ringed portion of one of the sheets being shown to an enlarged scale; and,

FIG. 6 is a plan view of a part of a currently-used KEVLAR sheeting of loosely-woven, lattice pattern where the weft and weave threads are of relatively large diameter (about 1½ mm) arranged perpendicularly to one another

### DESCRIPTION OF FIRST EMBODIMENT

FIG. 1 is a garment in the form of a jacket 1 having inbuilt protection provided by a reinforcing lining 2 disposed between an outer water-resistant fabric covering 3 and an inner fabric layer 4. The lining 2 offers protection to the upper body of a rider of a motor cycle in the event of the rider being thrown off when travelling at speed. Referring to FIGS. 3 and 4 the lining 2 is made from a sheet composed of parallel strips 5 of flat webbing made from closely-woven, high tenacity, continuous filament synthetic plastics fiber stitched together edge-to-edge on both sides. The strips are not woven to a conventional lattice pattern. Instead, some or all of the threads are set diagonally, for example with a herring-bone weave, and the diameter of the threads is only one millimeter which is much less than the thread diameter in lattice pattern KEVLAR sheeting currently used in protection linings. The sheet 4 so formed is flexible, permeable to moisture, and is largely resistant to penetration by sharp objects which may impact on the sheet with considerable force at any angle of incidence in the event of an accident. The material used for the webbing strips is commercially available in Australia as thin black seat-belt webbing for use on motor vehicles and which is approximately 50 mm wide and 1 mm thick. It has a breaking strain of 5 tons. A 400 mm×400 mm sheet of such webbing weighs approximately 2 kilograms.

### Description of Second Embodiment

The vehicle 10 shown in outline in FIG. 2 has a metal door panel 11 of 2 mm thick steel internally provided with a lining 12 offering protection against penetration by low and medium calibre bullets from hand-guns. The lining 12 is flexible and is made up from superimposed sheets 9 of webbing strips stitched together edge-to-edge on both sides of the sheet 9 as shown in FIGS. 3 and 4. The lining 12 is made up from several superimposed stacks of overlapping sheets 9, each stack being stitched together at its edges. As is apparent from FIG. 5, the positions of the webbing strips 8 in neighbouring sheets 9 are staggered with respect to one another. The flexibility of the multi-layer lining 12 enables it to follow closely any irregular surface contour of the internal surface of the door panel 11. Flat truck webbing is used for the strips 8.

I have found that when flat, polyester, continuous-filament closely-woven blue truck webbing commercially available in a width of 50 mm and a thickness of 1 mm, is used for the construction of the sheet, the lining required sixteen such sheets to stop a bullet from a 44 magnum hand-gun under ballistic test conditions. When red truck webbing, which has a slightly greater thickness is used, ten such sheets stop a 44 magnum bullet.

It appears that a greater number of sheets is necessary to stop a bullet of smaller size from a hand-gun if the bullet is metal jacketed. Thus when a lining composed of sheets of black, closely-woven, polyester seat belt webbing which is 50 mm wide and 1 mm thick is used for the sheet, the resultant lining required twenty-eight sheets to stop a 44 magnum bullet. However, thirty-four sheets were necessary to stop a 9 mm full-metal jacketed bullet from a pistol. The reason for this anomaly is not understood. From tests conducted on closely-woven non-lattice webbing made from different fiber materials, it appears that nylon is the least effective for stopping bullets of different calibres and type, as compared with webbing of the same dimensions made from different, cheaply-available, closely-woven plastics materials such as polyester, polypropylene or aramid polyamide. However, when the lining is mounted behind a 2 mm thick steel sheet such as a car door panel, the passage of a 9 mm full-metal jacketed bullet through the panel retards and blunts the bullet sufficiently for it to be stopped by a lining made up from sufficient sheets to stop a 44 magnum bullet without an intervening steel door panel.

Examples of herring-bone closely woven, polyester webbing I have found useful for carrying out the invention, are as follows:

| TYPE | BREAKING STRENGTH | WIDTH |
|---|---|---|
| 2-SBW 80 | 1,800 kg | 80 mm. |
| 2-SBW 25 | 1,000 kg | 25 mm. |
| 2-SBW 50c | 1,500 kg | 50 mm. |
| 2-TW 50L | 3,000 kg | 50 mm. |
| 2-TW 50(red) | 5,000 kg | 50 mm. |
| 2-TW 75 | 8,000 kg | 75 mm. |

(SBW = seat belt webbing; TW — truck webbing)

The following ballistic test results were obtained when test linings incorporating the invention were submitted to testing by independent testing companies licensed by the Australian government to perform such tests.

TEST A
In the following tabular presentation of test results the tests
performed were in accordance with Australian Test Standard
NIJ0101.03 and the tests were at level 3A. A
stack of parallel sheets or piles each composed of parallel
strips of seat-belt webbing stitched-together edge-to-edge as
described above, constituted each of the four
“panels” tested. The width of the strip in each case
is given in millimeters.

| | |
|---|---|
| Test Std: NIJ0101.03 Test Level: 3A | Requirements: R & D |
| | Size: 42 × 42 cm |

| | |
|---|---|
| Sample: | Panel 1:32 piles 100 mm wide narrow weave polyester |
| | seat belt belting |
| Description: | Panel 2:27 piles 50 mm narrow weave polyester |
| | seat belt belting |
| | Panel 3:25 piles 50 mm narrow weave polyester |
| | seat belt belting |
| | Panel 4:12 piles 50 mm narrow weave polyester truck |
| | tie down belting |

TEST EQUIPMENT AND CONDITIONS

| | | |
|---|---|---|
| Calibre: | Bullet Type: | Bullet Weight: 9 |
| 1. .44 | 1. LSWC GC | 1. 15. |
| 2. 9 mm | 2. FMJ | 2. 8.0 |
| 3. 3. | 3. | |
| Velocity: | (m/s +/−) Serial No: | Barrel Length: mm |
| 1. 438.5 7.5 | 1. TB44M128 | 1. 250 |
| 2. 433.5 7.5 | 2. TB919 | 2. 250 |
| 3. | 3. | 3. |

| | | |
|---|---|---|
| Temp: 26° C. | Rel Humidity: | 45% Range 5 m |
| Panel Condition: Dry | | |
| Backing Test: 1 | 24 mm 2. | 24 mm 3. |
| 24 mm | | |

RESULTS

| | |
|---|---|
| Workmanship: | Not applicable |
| Labelling: | Not applicable |
| Comments: | Shot 1 on panel 1 - velocity 1 m/s over limit |
| | Shot 1 on panel 3 - velocity 2 m/s over limit |
| Statement of | Not required |
| Compliance: | |

The ballistic results obtained from the tests were as follows: (Y=yes; N=no):

BALLISTIC RESULTS

| Panel | | | Angel | | | | |
|---|---|---|---|---|---|---|---|
| No: | Cal | Shot No: | (deg) | Vel m/s | Fair Hit | Penet | Deform |
| 1 | .44 | 1 | 0 | 442 | N | Y | Not tested |
| 2 | .44 | 1 | 0 | 436 | Y | N | 27 |
| 3 | .44 | 1 | 0 | 443 | N | Y | Not tested |
| 2 | 9 mm | 2 | 0 | 438 | Y | Y | Not tested |
| 4 | 9 mm | 1 | 0 | 440 | Y | Y | Not tested |

The reference to “deform” relates to a clay body placed behind the panel and is a measure of the amount of deformation it experienced as a result of the impact. A deformation of “27” is acceptable as it signifies a human body behind the panel will suffer physical injury but not be killed. A deformation value of “45” is necessary to denote killing.

The test showed that the second panel tested and composed of 27 superimposed sheets or piles will stop a 44 magnum bullet with acceptable injury to a person protected by the panel. Tests conducted on the 1^{st} and 3^{rd} panels should be disregarded as the test was not carried out with a “fair” hit. Likewise tests conducted on the 2^{nd} and 4^{th} panel using a steel jacketed 9 mm bullet showed penetration of the panel. Later tests corresponding to these but in which the panel was overlaid with a 2 mm thick steel car door showed penetration of the panel with a 9 mm steel jacketed bullet did not occur, possibly because the bullet was blunted sufficiently by its passage through the steel to be expanded and stopped within the thickness of the stack of sheets forming the panel.

TEST B
In the test results the overlapping sheets of the panels being tested are referred to as
“layers”. All the tests were carried out using a 9 mm steel jacketed bullet.

| | |
|---|---|
| Test Std: AS/NZ52343,97 Test Level: GO | Requirements: R & D |

| | |
|---|---|
| Sample | P1-34 layers 50 mm polyester seat belt web (Yellow) Size: 42 × 42 cm |
| Description: | P2-32 layers 50 mm polyester seat belt web (light blue) |
| | P3-20 layers 50 mm polyester heavy truck tie web (red) |
| | P5-22 layers 50 mm nylon extra heavy truck tie web (white) |

TEST EQUIPMENT AND CONDITIONS

| | | | | | |
|---|---|---|---|---|---|
| Calibre: 9 mm | | Bullet Type: | FMJ | Bullet Weight: | 8.0 |
| g | | | | | |
| Velocity: 405 | (m/s +/−) | 15Serial No: | TB919 | Barrel Length: | 250 mm |
| Temp: 24 | ° C. | Rel Humidity: | 55% | Range: | 3 m |
| Temp: | 26° C. | Rel Humidity: | 45% Range | | 5 m |
| Panel Condition: Dry | | | | | |
| Backing Test: 1 | | 24 mm 2. | 24 mm 3. | | 24 mm |

| Panel Condition: | | Not weathered | |
|---|---|---|---|
| Weathering Details: | City: | State: | Country: |

Start Date: Finish Date:
Deviation from Standard: Not weathered
Comments:
Comments:
Statement of compliance: Not required

The ballistic results of the tests carried out were as follows:

BALLISTIC RESULTS

| | | | | | | Witness Car | |
|---|---|---|---|---|---|---|---|
| Panel No: | Shot No: | Angel (deg) | Vel m/s | Fair Hit | Penet | Perforation | Pass/Fail |
| 1 | 1 | 0 | 394 | Y | Y | Y | F |
| 1 | 2 | 0 | 408 | Y | Y | Y | F |
| 1 | 3 | 0 | 417 | Y | Y | Y | F |
| 1 | 4 | 0 | 411 | Y | Y | Y | F |
| 2 | 1 | 0 | 417 | Y | Y | Y | F |
| 3 | 1 | 0 | 415 | Y | Y | Y | F |
| | 2 | 0 | 418 | Y | Y | Y | F |
| 5 | 1 | 0 | 415 | Y | N | N | P |

These tests show that, with the exception of the 5^{th} panel which had 22 layers of nylon extra heavy truck tie webbing, a steel jacketed bullet would penetrate the panel. However, once again when tests were carried out with the panels covered by a 2 mm steel plate simulating a car body sheet, the 9 mm bullet was stopped within the thickness of the panel.

TEST C
In these tests, three panels of sheets (referred to as “layers”) made of webbing strips as
described beneath and stitched together edge-to-edge, were tested with a 44 magnum
calibre bullet.

| | |
|---|---|
| Test Std: AS/NZ52343,97 Test Level: G2 | Requirements: R & D |

| | |
|---|---|
| Sample | P1-34 layers 50 mm polyester seat belt web Size: 42 × 42 cm |
| Description: | P2-32 layers 50 mm polyester truck tie web |
| | P3-20 layers 50 mm polyester heavy truck tie web |

TEST EQUIPMENT AND CONDITIONS

| | | | | | |
|---|---|---|---|---|---|
| Calibre: .44 | | Bullet Type: | LSWC-GC | Bullet Weight: | 15.6 |
| g | | | | | |
| Velocity: 480 | (m/s +/−) | 15 Serial No: | TB44M128 | Barrel Length: | 250 mm |
| Temp: 24 | ° C. | Rel Humidity: | 55% | Range: | 3 m |
| Temp: | 26° C. | Rel Humidity: | 45% Range | | 5 m |
| Panel Condition: Dry | | | | | |
| Backing Test: 1 | | 24 mm | 3. | | 24 mm |
| | | 2.24 mm | | | |

| Panel Condition: | | Not weathered | |
|---|---|---|---|
| Weathering Details: | City: | State: | Country: |

Start Date: Finish Date:
Deviation from Standard: Not weathered
Comments:
Comments:
Statement of compliance: Not required

The ballistic results of the tests were as follows:

BALLISTIC RESULTS

| Panel | | | Angel | | | Witness Card |
|---|---|---|---|---|---|---|
| No: | Shot No: | (deg) | Vel m/s | Fair Hit | Penet | Perforation |
| 1 | 1 | 0486 | Y | N | N | P |
| 2 | 2 | 0485 | Y | N | N | P |
| 3 | 1 | 0495 | Y | N | N | P |

It will be observed that in all cases the panels withstood penetration by a 44 magnum bullet and the panels passed the tests.

Although the linings of the invention have been specifically described with reference to garments and vehicles it is noted that some houses in the United States now call for protection against bullets to be incorporated as linings to their doors etc. It is believed that the linings of the invention will meet this requirement.

1. A protective flexible lining comprises one or more superimposed flat sheets made up from parallel strips of a closely woven, non-lattice, pattern webbing stitched together side-by-side and fabricated from a high-tenacity, continuous filament, synthetic plastics fiber material.

2. A garment to be worn over the upper part of a person's body and incorporating a lining as claimed in claim 1.

3. A lining as claimed in claim 1, comprising a stack of overlapping sheets stitched together at their edges and for fitting inside the external body panels of a vehicle to resist injury or damage to its occupants or its operating parts.

4. A lining as claimed in claim 3, in which the strips of neighbouring sheets are staggered with respect to one another.

5. A lining as claimed in any one of claims 1-4, in which the material of the strips is polyester webbing.

6. A lining as claimed in claim 1, constructed substantially as described with reference to FIGS. 3 and 4, or FIG. 5 of the accompanying drawings.

7. A garment as claimed in claim 2, constructed substantially as described with reference to FIG. 1 of the accompanying drawings.

8. A vehicle having one or more body panels provided with linings as claimed in claim 1 and substantially as described with reference to FIGS. 2 and 5 of the accompanying drawings.
